(19) United States
(12) Patent Application Publication
(10) Pub. No.: US 2026/0243565 A1
(43) Pub. Date: Aug. 20, 2026

(54) MEASUREMENT SYSTEM AND MEASUREMENT METHOD

(71) Applicant: NTT, Inc., Tokyo (JP)

(72) Inventors: Daisuke UCHIBORI, Tokyo (JP); Shohei YAMASHITA, Tokyo (JP); Yosuke SAKURADA, Tokyo (JP)

(73) Assignee: NTT, Inc., Tokyo (JP)

(21) Appl. No.: 19/489,532

(22) PCT Filed: Jun. 2, 2023
(86) PCT No.: PCT/JP2023/020707

§ 371 Date: Dec. 2, 2025

(51) Int. Cl. G01C 3/02; G06T 7/73

(52) U.S. Cl. CPC G01C 3/02; G06T 7/73

(57) ABSTRACT

A measurement system (100) according to the present disclosure includes a measurement device (20) and an information processing device (30), in which the measurement device 20 includes a position measurement instrument (21) that measures a second absolute position (P₂), a laser range finder (22) that measures a measurement distance (L₁) that is a distance from a measurement position, and an orientation measurement instrument (24) that measures an orientation in a distance measurement direction of the laser range finder (22), and the information processing device (30) includes an absolute position calculation unit (34) that calculates a first absolute position (P₁) on the basis of a first relative position that is a relative position of the laser range finder (22) with respect to the second absolute position (P₂), a second relative position that is a relative position of a target with respect to a measurement position (P₃), the second absolute position, the distance measurement (L₁), and the orientation when the measurement device (20) is installed such that the position measurement instrument (21) is located on the ground (C) and the laser range finder (22) is located in the internal space (B) such that the distance measurement direction is a horizontal direction.

### TECHNICAL FIELD

The present disclosure relates to a measurement system and a measurement method.

### BACKGROUND ART

A manhole for accommodating a communication cable extending from a communication base station to each home or the like is buried underground. The manhole includes a framework portion defining a rectangular parallelepiped internal space, a neck portion communicating the internal space with the ground, and an iron lid that is provided on the ground side of the neck portion to close the internal space. The framework portion generally has the height of about 1.5 m, the length of about 2.3 m, and the width of about 1.3 m. The internal space of the framework portion communicates with an internal space of another adjacent manhole via a pipeline having one end attached to a duct portion provided on a wall surface of the framework portion. A part of the communication cable is connected or switched to a part of another communication cable in the framework portion. Other parts of the communication cable are accommodated in the pipeline.

A position of the manhole is relatively grasped from a linear shape of a road by measuring a relative position of the center of the iron lid of the manhole with respect to a surrounding road. Therefore, in a case where the linear shape changes due to widening or the like of the road, the position of the manhole cannot be grasped in some cases. Therefore, it is known to measure an absolute position of the center of the iron lid of the manhole by using a global positioning system (GPS) such that the position of the manhole can be recognized even in a case where the linear shape changes. It is necessary to grasp a position of the cable provided underground so as not to erroneously cut the underground cable when the ground is excavated for the purpose of repairing equipment buried underground. Therefore, it is required to measure an absolute position of a duct outlet through which the cable exits from the manhole.

Meanwhile, in some cases, a global positioning system (GPS) signal cannot be received in the internal space of the framework portion of the manhole. Therefore, as disclosed in Non Patent Literature 1, a position in the internal space of the manhole can be estimated by using the absolute position measured by using the GPS and movement information of a worker.

### CITATION LIST

### Non Patent Literature

Non Patent Literature 1: Ryo Ogawara and four others, “Location Estimation System Based on GPS Positioning and Sensor Information”, Transactions of Information Processing Society of Japan, Vol. 56, No. 1, pp. 2-12 Jan. 2015

### SUMMARY OF INVENTION

### Technical Problem

However, because the internal space of the framework portion of the manhole is narrow, and the communication cable and the like are installed, a worker's moving in the internal space is restricted in some cases. Further, for the same reason, it is difficult to measure a distance from a position measured by using the GPS to a position of a target such as the center of the duct outlet by using a measure. This makes it difficult to measure an absolute position of the target in the internal space of the manhole with high accuracy.

An object of the present disclosure that has been made in view of such circumstances is to provide a measurement system and a measurement method capable of easily measuring an absolute position of a target in an internal space provided underground with high accuracy.

### Solution to Problem

In order to solve the above problems, a measurement system according to the present disclosure is a measurement system that measures a first absolute position that is an absolute position of a target in an internal space provided underground, the measurement system including: a measurement device; and an information processing device, in which: the measurement device includes a position measurement instrument that measures a second absolute position that is an absolute position of the position measurement instrument by using a signal received from a satellite, a laser range finder that measures a measurement distance that is a distance from a measurement position, and an orientation measurement instrument that measures an orientation in a distance measurement direction of the laser range finder; and the information processing device includes an absolute position calculation unit that calculates the first absolute position on the basis of a first relative position that is a relative position of the laser range finder with respect to the second absolute position and a second relative position that is a relative position of the target with respect to the measurement position, the second absolute position, the measurement distance, and the orientation when the measurement device is installed such that the position measurement instrument is located on the ground and the laser range finder is located in the internal space such that the distance measurement direction is a horizontal direction.

In order to solve the above problems, a measurement method according to the present disclosure is a measurement method for measuring a first absolute position that is an absolute position of a target in an internal space provided underground, the measurement method including: a step of installing a measurement device including a position measurement instrument that measures a second absolute position that is an absolute position of the position measurement instrument by using a signal received from a satellite and a laser range finder that measures a measurement distance that is a distance from a measurement position, the step being a step of installing the measurement device such that the position measurement instrument is located on the ground and the laser range finder is located in the internal space such that a distance measurement direction of the laser range finder is a horizontal direction; a step of measuring the second absolute position; a step of measuring an orientation in the distance measurement direction; and a step of calculating the first absolute position on the basis of a first relative position that is a relative position of the laser range finder with respect to the second absolute position and a second relative position that is a relative position of the target with respect to the measurement position, the second absolute position, the measurement distance, and the orientation in the distance measurement direction when the measurement device is installed such that the position measurement instrument is located on the ground and the laser range finder is located in the internal space.

### Advantageous Effects of Invention

According to a measurement system and a measurement method of the present disclosure, it is possible to easily acquire an absolute position of a target in an internal space provided underground with high accuracy.

### BRIEF DESCRIPTION OF DRAWINGS

FIG. 1 is a schematic view showing an example of a manhole having a duct outlet whose absolute position is measured by a measurement system according to the present embodiment.

FIG. 2 is a schematic view showing an example of the measurement system according to the present embodiment.

FIG. 3A shows a measurement device of FIG. 2 in detail.

FIG. 3B shows an example where the measurement device of FIG. 3A is modified.

FIG. 4 shows an example of an image generated by an imaging unit of FIG. 3A.

FIG. 5 is a functional block diagram showing an example of an information processing device of FIG. 2.

FIG. 6 is a flowchart showing an example of an operation by a measurement method according to the present embodiment.

FIG. 7 is a flowchart showing a detailed example of an operation of installing a measurement device of FIG. 6.

FIG. 8 shows a measurement device in a modification of the measurement system of the present embodiment.

FIG. 9 shows an example of a fixing tool included in a modification of the measurement system of the present embodiment.

FIG. 10 shows an example of a hardware configuration of an information processing device.

### DESCRIPTION OF EMBODIMENTS

A measurement system 100 of the present embodiment will be described with reference to the drawings.

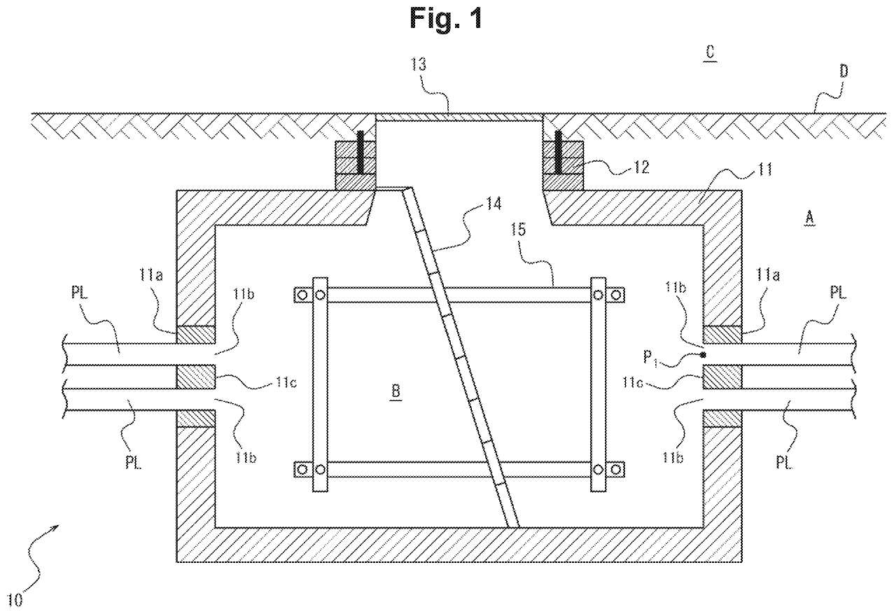

First, a structure 10 in which the measurement system 100 according to the present embodiment is installed will be described with reference to FIG. 1.

The structure 10 can include a framework portion 11, a neck portion 12, an iron lid 13, a ladder 14, and a cable attaching member 15. The structure 10 can be, for example, a manhole.

The framework portion 11 defines an internal space B. The framework portion 11 may be made from reinforced concrete, for example. The internal space B can have, for example, a rectangular parallelepiped shape. A duct portion 11a formed on a part of a side surface of the framework portion 11 is provided with a pipeline PL for communicating the internal space B with another internal space provided underground A. An inlet to the pipeline PL, which is an opening defined by the side surface of the framework portion 11, is referred to as a duct outlet 11b. A surface of the duct portion 11a on the internal space B side is referred to as a duct surface 11c.

The neck portion 12 communicates the internal space B with the ground C. The neck portion 12 may be made from reinforced concrete, for example.

The iron lid 13 is a member attachable in the neck portion 12 in the same plane as a ground surface D. The internal space B is closed with respect to the ground C by attaching the iron lid 13 to the neck portion 12.

The ladder 14 is used for a worker to enter the internal space B from the ground C.

The cable attaching member 15 is a member for attaching a communication cable or the like. The cable attaching member 15 may be a steel material.

The measurement system 100 measures a first absolute position P₁ that is an absolute position P₁ of a target in the internal space B provided underground A as shown in FIG. 1. The target may be an opening (e.g. the duct outlet 11b) defined by the side surface of the structure 10 defining the internal space B. Hereinafter, the first absolute position P₁ is also referred to as the “position P₁ of the target”.

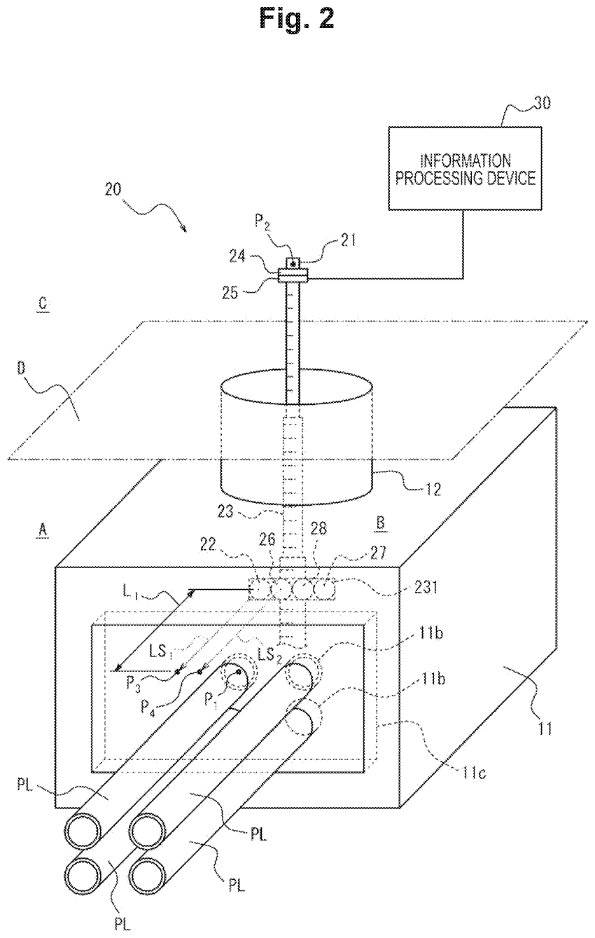

As shown in FIG. 2, the measurement system 100 includes a measurement device 20 and an information processing device 30.

### <Configuration of Measurement Device>

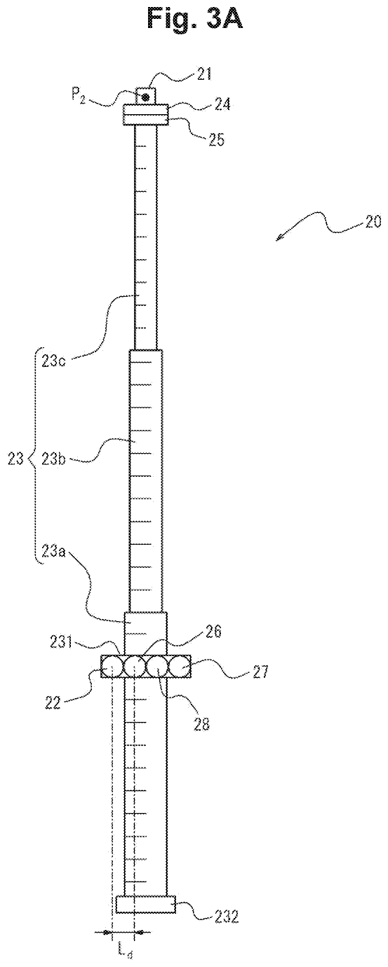

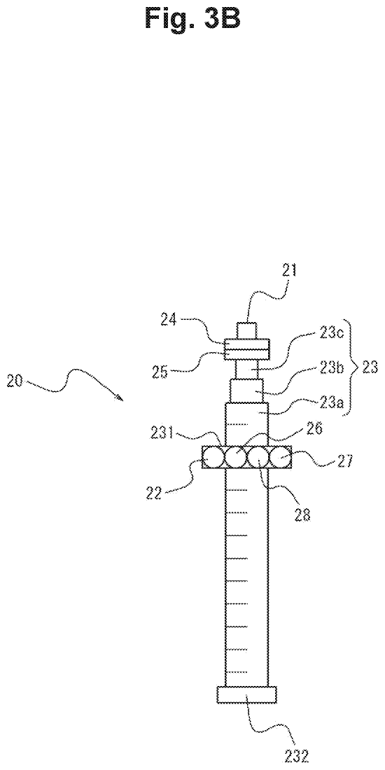

As shown in FIG. 3A, the measurement device 20 includes a position measurement instrument 21, a laser range finder 22, a jig 23, an orientation measurement instrument 24, a level 25, a laser pointer 26, a lighting device 27, and an imaging unit 28.

The position measurement instrument 21 measures a second absolute position P₂ that is an absolute position P₂ of the position measurement instrument 21 by using a signal received from a satellite, Hereinafter, the second absolute position P₂ is also referred to as the “position P₂ of the position measurement instrument 21”. The position measurement instrument 21 can be a GNSS receiver of a satellite navigation system (global navigation satellite system (GNSS)). The satellite can be a satellite of the satellite navigation system. The satellite navigation system can be a quasi-zenith satellite system (QZSS), a global positioning system (GPS), or the like. As shown in FIG. 2, the measurement device 20 is disposed such that the position measurement instrument 21 is located on the ground C. In such a configuration, the position measurement instrument 21 can measure the second absolute position P₂ that is the absolute position P₂ of the position measurement instrument 21 by a known method by using a GNSS signal received from a GNSS satellite.

Returning to FIG. 3A, the laser range finder 22 measures a measurement distance L₁ that is a distance from a measurement position P₃ as shown in FIG. 2. The measurement position P₃ is a position where the laser range finder 22 measures a distance from the laser range finder 22. As described above, in a configuration in which the target is the opening (duct outlet 11b) defined by the side surface of the structure 10 defining the internal space B, the measurement position P₃ is a position on the side surface (duct surface 11c) of the structure 10. The laser range finder 22 is disposed in the internal space B such that a distance measurement direction is a normal direction of the duct surface 11c. Therefore, the measurement position P₃ is an intersection between a straight line extending from the laser range finder 22 in the distance measurement direction (normal direction of the duct surface 11c) and the duct surface 11c.

Returning to FIG. 3A, the laser range finder 22 is provided such that a direction orthogonal to an extending direction of the jig 23 described in detail later is the distance measurement direction. Therefore, when the measurement device 20 is installed by the worker such that the extending direction of the jig 23 is a vertical direction, the distance measurement direction is a horizontal direction. The measurement device 20 is installed also such that the distance measurement direction of the laser range finder 22 is the normal direction of the duct surface 11c by visual observation or the like of the worker. The measurement device 20 is installed also such that the measurement position P₃ is located on the duct surface 11c.

The jig 23 can hold the position measurement instrument 21 and the laser range finder 22 along the extending direction. The jig 23 holds the laser range finder 22 such that the distance measurement direction of the laser range finder 22 is orthogonal to the extending direction. Therefore, when the jig 23 is installed such that the extending direction is the vertical direction, the distance measurement direction of the laser range finder 22 is the horizontal direction. As an example, the jig 23 may be a columnar member, the position measurement instrument 21 may be provided at an end on one side in the extending direction of the jig 23, and the laser range finder 22 may be provided to be movable in the extending direction. The jig 23 may further hold the level 25, the orientation measurement instrument 24, the laser pointer 26, the imaging unit 28, and the lighting device 27, and thus the position measurement instrument 21, the laser range finder 22, the level 25, the orientation measurement instrument 24, the laser pointer 26, the imaging unit 28, and the lighting device 27 may be integrally configured.

The jig 23 may be made from a material that is light enough to be held by the worker's hand and has rigidity, such as carbon. The length of the jig 23 may be appropriately designed according to the depth of the internal space B. The jigs 23 having a plurality of length patterns may be used to be applicable to the internal spaces B defined by various types of structures 10. In this case, the jigs 23 are selectively used according to the depth of the internal space B. For example, a light jig 23 having a short length is used in a case where the internal space B is relatively shallow, which makes it possible to improve workability.

An installation base 231 and a base 232 may be attached to the jig 23.

The installation base 231 is attached to be movable in the extending direction of the jig 23. The installation base 231 may hold the laser range finder 22. The installation base 231 may further hold the laser pointer 26, the imaging unit 28, and the lighting device 27. Therefore, the installation base 231 moves in the extending direction, and the laser range finder 22, the laser pointer 26, the imaging unit 28, and the lighting device 27 also move in the extending direction. Because the installation base 231 moves in the extending direction in this manner, the laser range finder 22 can be installed such that the measurement position P₃ is located on the duct surface 11c.

The base 232 is a member that erects the jig 23 on a bottom surface of the framework portion 11 such that the extending direction of the jig 23 is the vertical direction. The base 232 may be attached to the jig 23 on the side opposite to the side on which the position measurement instrument 21 is attached in the extending direction. For example, the base 232 may have a plane whose normal line is the extending direction of the jig 23. The base 232 may be made from rubber. Therefore, the measurement device 20 can be stably installed even in a case where a bottom surface of the internal space B is wet due to accumulation of water in the internal space B.

The jig 23 may be provided with a scale indicating a distance in the extending direction of the jig 23. This makes it possible to calculate a first relative position that is a relative position of the laser range finder 22 with respect to the second absolute position P₂ (position P₂ of the position measurement instrument 21). For example, in a configuration in which the laser range finder 22 is provided on the installation base 231, a relative position of a part of the installation base 231 where the laser range finder 22 is provided with respect to a part of the installation base 231 abutted on the jig 23 is determined by design and is known. Therefore, a position, which is further apart from the part of the installation base 231 abutted on the jig 23 apart from the position measurement instrument 21 in the extending direction by a distance indicated by the scale, can be calculated as the first relative position.

The jig 23 may be expandable and contractible in the extending direction. For example, as shown in FIGS. 3A and 3B, the jig 23 may have a first jig portion 23a, a second jig portion 23b, and a third jig portion 23c. The outer diameter of the second jig portion 23b may be equal to or smaller than the inner diameter of the first jig portion 23a. In such a configuration, as shown in FIG. 3B, at least a part of the second jig portion 23b is accommodated in the first jig portion 23a, whereby the jig 23 can be contracted in the extending direction. The outer diameter of the third jig portion 23c may be equal to or smaller than the inner diameter of the second jig portion 23b. At least a part of the third jig portion 23c is accommodated in the second jig portion 23b, whereby the jig 23 can be contracted in the extending direction. Therefore, by expanding and contracting the jig 23 according to the depth of the bottom surface of the internal space B, the measurement device 20 can be installed such that the position measurement instrument 21 is located on the ground C and the laser range finder 22 is located at the same height as the target (e.g. the center of the duct outlet 11b) in the internal space B. For example, the measurement device 20 can be easily handled by contracting the jig 23 when measurement using the measurement device 20 is not executed (e.g. when the measurement device 20 is conveyed).

The orientation measurement instrument 24 measures an orientation in the distance measurement direction. The orientation measurement instrument 24 can be, for example, a compass and, specifically, can be an electronic compass. The orientation measurement instrument 24 may indicate a predetermined orientation (e.g. North) and measure a distance measurement orientation by measuring an angle between the predetermined orientation and the distance measurement orientation. The orientation measurement instrument 24 may be provided in the jig 23. In the example of FIGS. 3A and 3B, the orientation measurement instrument 24 is provided adjacent to the position measurement instrument 21 in the extending direction, but the present invention is not limited thereto.

The level 25 indicates whether or not the extending direction of the jig 23 is the vertical direction. The above first relative position may be calculated by using the distance indicated by the above scale when the level 25 indicates that the extending direction is the vertical direction. Specifically, the worker installs the jig 23 by using the level 25 such that the extending direction of the jig 23 is the vertical direction. As described above, the laser range finder 22 is provided in the jig 23 such that the distance measurement direction is a direction orthogonal to the extending direction. Thus, the distance measurement direction becomes the horizontal direction. In the example of FIG. 3A, the level 25 is provided adjacent to the orientation measurement instrument 24 in the extending direction, but the present invention is not limited thereto.

The laser pointer 26 is installed at a design relative position with respect to the laser range finder 22 and emits a laser beam LS₂ (see FIG. 2) in a direction parallel to the distance measurement direction. The laser pointer 26 may be provided on the installation base 231 as described above. In the example of FIG. 3A, a laser irradiation port of the laser pointer 26 is provided apart from a laser irradiation port of the laser range finder 22 by a design distance L_{d} (in one example, 20 mm) in a direction orthogonal to the extending direction of the jig 23 and to the distance measurement direction of the laser range finder 22. Therefore, when the laser range finder 22 is installed such that the distance measurement direction is the normal direction of the duct surface 11c, an irradiation position Pa is a position apart from the measurement position P₃ in the horizontal direction by the design distance L_{d} (in the above example, 20 mm) in the duct surface 11c.

The lighting device 27 emits irradiation light. The lighting device 27 is a light source provided at an arbitrary position so as to irradiate an area including the position P₁ of the target and the irradiation position P₄ of the laser pointer 26 (e.g. area imaged by the imaging unit 28). The lighting device 27 may be provided on the installation base 231 as described above. In the example of FIG. 3A, the lighting device 27 is provided on the installation base 231 so as to be adjacent to the imaging unit 28 in a direction orthogonal to the extending direction of the jig 23 and to the distance measurement direction of the laser range finder 22. When the lighting device 27 irradiates the area including the position P₁ of the target and the irradiation position P₄ of the laser pointer 26, images of the target and a portion irradiated by the laser pointer 26 can be clearly appear in an image generated by the imaging unit 28 described later even in a case where the internal space B is dark.

The imaging unit 28 generates an image by imaging the area including the position P₁ of the target and the irradiation position P₄. The area may include the measurement position P₃. The imaging unit 28 can be, for example, a camera.

The imaging unit 28 is provided such that an optical axis of the imaging unit 28 is parallel to the distance measurement direction of the laser range finder 22. The position where the imaging unit 28 is provided may be determined according to an angle of view of the imaging unit 28 such that the position P₁ of the target and the irradiation position P₄ are included in an imaging range of the imaging unit 28.

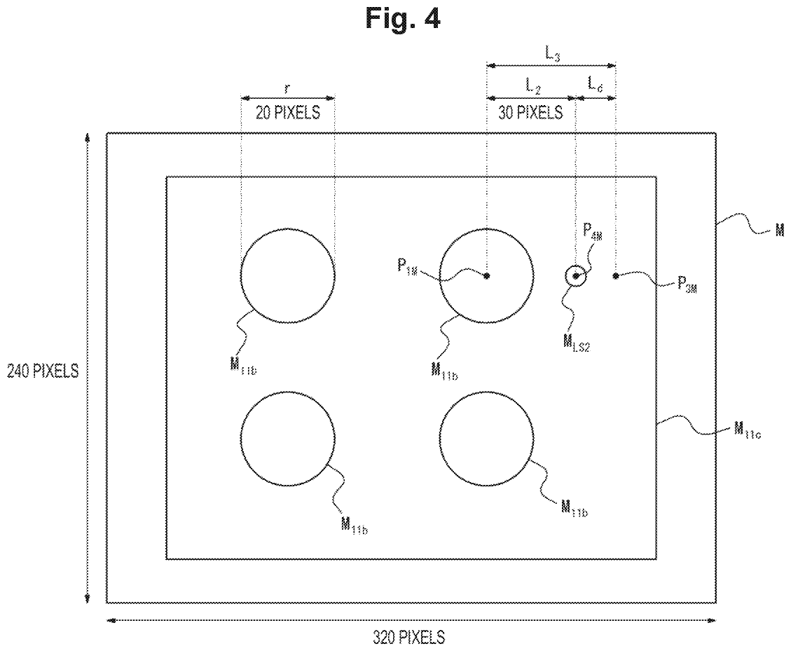

In a case where the target is the center of the duct outlet 11b, the imaging unit 28 images an area including the duct outlet 11b and the irradiation position P₄ on the duct surface 11c. Therefore, as shown in FIG. 4, the image generated by the imaging unit 28 includes images M_{11b} of the duct outlets 11b, an image M_{11C} of the duct surface 11c, and an image M_{LS2} of a portion irradiated with the laser beam LS₂ emitted by the laser pointer 26. An in-image irradiation position P_{4M}, which is a position in the image corresponding to the irradiation position P₄ in a real space, is the center of the image M_{LS2}. Note that a laser beam LS₁ emitted by the laser range finder 22 is a laser beam that is not visually recognized by humans, and a portion irradiated with the laser beam LS₁ in the image is not visually recognized. However, in order to simplify the description, FIG. 4 shows an in-image measurement position P_{3M} that is a position in the image corresponding to the measurement position P₃. FIG. 4 also shows an in-image target position P_{1M} that is a position in the image corresponding to the position P₁ of the target (in this example, the center of the duct outlet 11b) in the real space.

The imaging unit 28 may be provided on the installation base 231 as described above. In the example of FIG. 3A, the imaging unit 28 is provided on the installation base 231 so as to be adjacent to the laser pointer 26 in a direction orthogonal to the extending direction of the jig 23 and to the distance measurement direction of the laser range finder 22.

The worker can determine whether or not water is accumulated in the internal space B by referring to an image of the internal space B generated by the imaging unit 28 when the measurement device 20 is installed (specifically, when the jig 23 is inserted into the internal space B). In such a configuration, when determining that water is accumulated in the internal space B, the worker can discharge the water by using a drainage mechanism such as a pump provided in the structure 10. In a case where the worker is on the ground, it is difficult to directly visually recognize the duct outlet 11b that is an example of the target, but by referring to an image, the worker can discharge water quickly as compared with a case of entering the internal space and confirming whether or not water is accumulated.

### <Configuration of Information Processing Device>

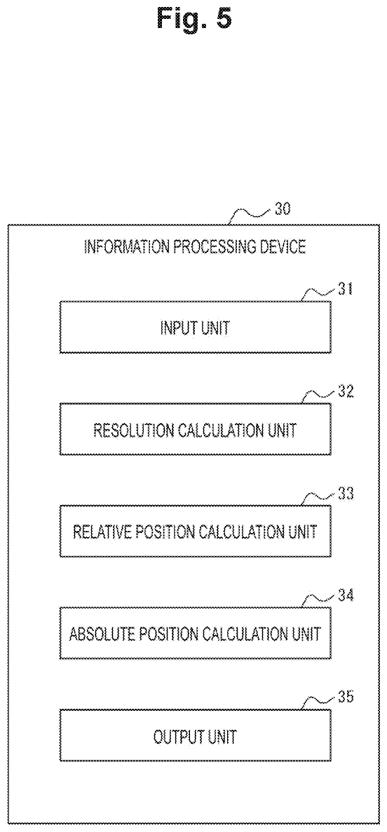

As shown in FIG. 5, the information processing device 30 includes an input unit 31, a resolution calculation unit 32, a relative position calculation unit 33, an absolute position calculation unit 34, and an output unit 35.

The input unit 31 includes an input interface. The input interface may include a pointing device, a keyboard, a mouse, or the like. The input interface may include a communication interface. For the communication interface, for example, a standard such as Ethernet (registered trademark), fiber distributed data interface (FDDI), or Wi-Fi (registered trademark) may be used. The resolution calculation unit 32, the relative position calculation unit 33, and the absolute position calculation unit 34 include a controller. The controller may include dedicated hardware such as an application specific integrated circuit (ASIC) or a field-programmable gate array (FPGA), may include a processor, or may include both thereof. The output unit 35 includes an output interface. The output interface may include a display interface or may include a communications interface. The display interface may be an organic electro luminescence (EL), a liquid crystal panel, or the like.

The input unit 31 receives input of the second absolute position P₂, the measurement distance L₁, and the distance measurement direction when the position measurement instrument 21 is located on the ground C and the laser range finder 22 is installed to be located in the internal space B such that the distance measurement direction is the horizontal direction. The input unit 31 may further receive input of the first relative position and the design relative position. The input unit 31 may not receive the input of the design relative position, and in such a configuration, the information processing device 30 may include a memory that stores the design relative position.

The input unit 31 receives input of an image generated by the imaging unit 28 and obtained by imaging the area including the position P₁ of the target and the irradiation position P₄.

The resolution calculation unit 32 calculates a pixel resolution that is a distance in the real space per unit pixel in the image. Specifically, the resolution calculation unit 32 can calculate the pixel resolution by dividing a distance in the real space from an object whose image appears in the image by the number of pixels indicating the image in the image.

In the example of FIG. 4, the inner diameter r of the duct outlet 11b in the real space is a known standard value and is 83 mm. The number of pixels corresponding to the inner diameter of the image of the duct outlet 11b in the image is 20 pixels. In this example, the resolution calculation unit 32 calculates the pixel resolution as expressed in Equation (1) below. In a case where images of a plurality of duct outlets 11b are shown in the image, the resolution calculation unit 32 may calculate the pixel resolution by using the image of any duct outlet 11b.

$$\begin{matrix}Pixel resolution = 83 ( mm ) / 20 ( pixels ) \\ = 4.15 ( mm / pixel )\end{matrix} \qquad ( 1 )$$

The relative position calculation unit 33 calculates a second relative position by using the in-image target position P_{1M} and the in-image irradiation position P_{4M} (see FIG. 4) that are positions in the image corresponding to the position P₁ of the target and the irradiation position P₄ (see FIG. 2) in the real space, the pixel resolution that is a distance in the real space per unit pixel of the image, and the design relative position. The second relative position is a relative position of the target with respect to the measurement position P₃. The design relative position is a relative position of the laser pointer 26 with respect to the laser range finder 22.

Specifically, first, the relative position calculation unit 33 calculates a distance from the position P₁ of the target to the irradiation position P₄ in the real space by multiplying the number of pixels from the in-image target position P_{1M} to the in-image irradiation position PAM by the pixel resolution. In the example of FIG. 4, the number of pixels from the in-image target position P_{1M} to the in-image irradiation position P_{4M} is 30 pixels. In this example, the relative position calculation unit 33 calculates a distance L₂ from the position P₁ of the target to the irradiation position P₄ as expressed by Equation (2) below.

$$\begin{matrix}Distance {L}_{2} = 30 ( pixels ) \times 4.15 ( mm / pixel ) \\ = 124.5 ( mm )\end{matrix} \qquad ( 2 )$$

Then, the relative position calculation unit 33 calculates a distance L₃ from the position P₁ of the target to the measurement position P₃ in the real space on the basis of the distance L₂ from the position P₁ of the target to the irradiation position P₄ and the design distance L_{d} from the measurement position P₃ to the irradiation position P₄ in the real space. As described above, the design distance L_{d} is a distance from the laser range finder 22 to the laser pointer 26 located at the design relative position with respect to the laser range finder 22.

Specifically, the relative position calculation unit 33 calculates the distance Ly by adding or subtracting the design distance L_{d} to or from the distance L₂. For example, as shown in FIG. 5, in a case where the irradiation position P₄ is between the measurement position P₃ and the position P₁ of the target, the relative position calculation unit 33 calculates the distance L₃ by adding the design distance L_{d} to the distance L_{d}. In the example of FIG. 5, the distance L₂ is 20.0 mm. In this example, the relative position calculation unit 33 calculates the distance L₃ as expressed by Equation (3) below.

$$\begin{matrix}Distance {L}_{3} = 124.5 ( mm ) + 20. ( mm ) \\ = 144.5 ( mm )\end{matrix} \qquad ( 3 )$$

In a case where the measurement position P₃ is between the irradiation position P₄ and the position P₁ of the target, the relative position calculation unit 33 calculates the distance Ly by subtracting the design distance L_{d} from the distance L₂.

The absolute position calculation unit 34 calculates the first absolute position P₁ on the basis of the first relative position that is a relative position of the laser range finder 22 with respect to the second absolute position P₂ (position of the position measurement instrument 21) and the second relative position that is a relative position of the target with respect to the measurement position P₃, the second absolute position P₂, the measurement distance L₁, and the orientation when the measurement device 20 is installed such that the position measurement instrument 21 is located on the ground C and the laser range finder 22 is located in the internal space B such that the distance measurement direction is the horizontal direction. The second absolute position P₂ can be set as an absolute position of the position measurement instrument 21 when the distance measurement direction becomes the horizontal direction by installing the jig 23 such that the extending direction is the vertical direction by using the level 25. In the present embodiment, the distance measurement direction is the horizontal direction and is also the normal direction of the duct surface 11c.

Specifically, the absolute position calculation unit 34 can calculate, as the first absolute position P₁, a position located at the second relative position (position apart by the distance L₃ in the horizontal direction in the plane of the duct surface 11c) from a position (measurement position P₃) apart by the measurement distance L₁ in the distance measurement direction from a position located at the first relative position (position of the laser range finder 22) with respect to the second absolute position P₂.

The output unit 35 outputs the first absolute position P₁. Specifically, the output unit 35 may transmit the first absolute position P₁ to another device via a communication network. The output unit 35 may display the first absolute position P₁ on a display device.

### <Operation Using Measurement Device>

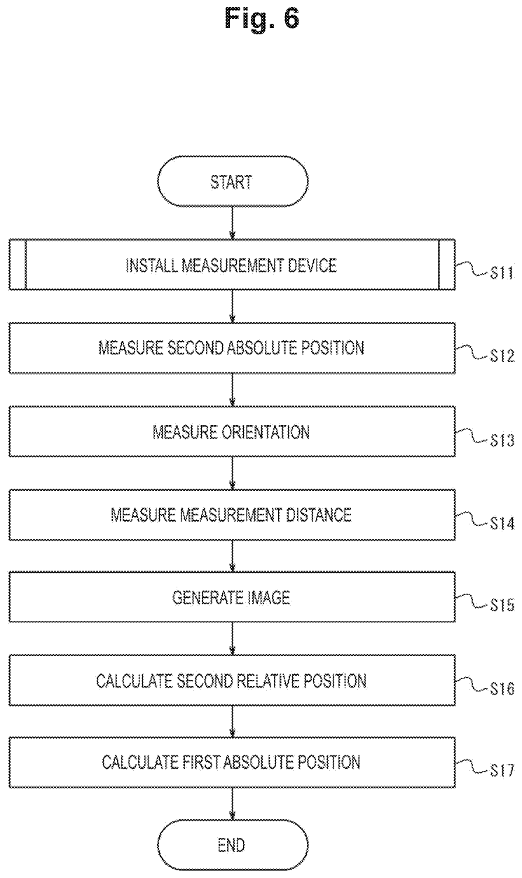

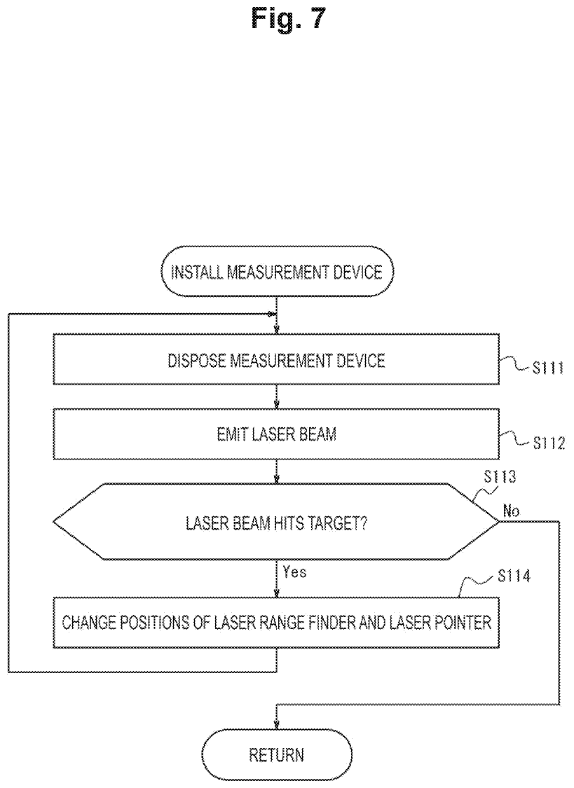

Next, an operation for measuring the first absolute position P₁ that is the absolute position P₁ of the target in the internal space B provided underground A according to the present embodiment will be described with reference to FIGS. 6 and 7. FIGS. 6 and 7 are flowcharts showing an example of the operation for measuring the first absolute position P₁ that is the absolute position P₁ of the target in the internal space B provided underground A according to the present embodiment. The operation of the measurement device 20 described with reference to FIGS. 6 and 7 corresponds to a measurement method for measuring the first absolute position P₁ that is the absolute position P₁ of the target in the internal space B provided underground A according to the present embodiment. In the present example, the target is an opening (duct outlet 11b) defined by the side surface of the structure 10 defining the internal space B, and the measurement position P₃ is a position on the side surface (duct surface 11c).

As shown in FIG. 6, the measurement device 20 is installed in step S11. Specifically, the measurement device 20 is installed such that the position measurement instrument 21 is located on the ground C and the laser range finder 22 is located in the internal space B such that the distance measurement direction is the horizontal direction. In a configuration in which the target is the duct outlet 11b, the measurement device 20 is installed such that the distance measurement direction is the normal direction of the duct surface 11c. As described above, the measurement device 20 includes the position measurement instrument 21 that measures the second absolute position P₂ by using a signal received from a satellite and the laser range finder 22 that measures the measurement distance L₁ that is a distance from the measurement position P₃. In the measurement device 20 of the present example, the laser pointer 26 that emits a laser beam in a direction parallel to the distance measurement direction is provided at the design relative position with respect to the laser range finder 22.

Here, the operation of installing the measurement device 20 in step S11 will be described in detail with reference to FIG. 7.

In step S111, the measurement device 20 is disposed such that the extending direction of the jig 23 is the vertical direction. At this time, the measurement device 20 may be disposed by the worker on the ground C lowering the measurement device 20 from the ground C into the internal space B, or the measurement device 20 may be disposed by the worker entering the internal space B while carrying the measurement device 20. In a case where the measurement device 20 is disposed by the worker on the ground C lowering the measurement device 20 from the ground C into the internal space B, the worker can easily install the measurement device 20 without being required to perform work in the narrow internal space B where the communication cable and the like are installed.

At this time, the worker may adjust the position of the installation base 231 in the jig 23 in advance on the basis of design specifications or the like of the structure 10 such that the height from the end of the jig 23 on the base 232 side to the laser range finder 22 and the laser pointer 26 is the height from the bottom surface of the internal space B to the center of the duct outlet 11b.

In step S112, the laser pointer 26 is caused to emit the laser beam LS₂.

In step S113, it is determined whether or not the laser beam LS₂ emitted by the laser pointer 26 hits the duct outlet 11b. At this time, the worker may visually determine whether or not the laser beam LS₂ hits the duct outlet 11b or may determine whether or not the laser beam LS₂ hits the duct outlet 11b by referring to an image captured by the imaging unit 28.

If it is determined in step S113 that the laser beam LS₂ hits the duct outlet 11b, in step S114, the positions of the laser range finder 22 and the laser pointer 26 are changed without changing the design relative position. As described above, the design relative position is a relative position of the laser pointer 26 with respect to the laser range finder 22. At this time, the position of the installation base 231 on which the laser range finder 22 and the laser pointer 26 are installed may be changed, and in this case, the positions of the lighting device 27 and the imaging unit 28 installed together on the installation base 231 are also changed.

If it is determined in step S113 that the laser beam LS₂ does not hit the duct outlet 11b, processing of installing the measurement device 20 ends, and the operation in step S12 is executed.

Returning to FIG. 6, in step S12, the position measurement instrument 21 measures the second absolute position P₂.

In step S13, the orientation measurement instrument 24 measures the orientation in the distance measurement direction.

In step S14, the laser range finder 22 measures the measurement distance L₁.

In step S15, the imaging unit 28 generates an image by imaging the area including the position P₁ of the target and the irradiation position P₄.

In step S16, the information processing device 30 calculates the second relative position by using the in-image target position P_{1M} and the in-image irradiation position P_{4M} that are positions in the image corresponding to the position P₁ of the target and the irradiation position P₄ in the real space and the pixel resolution that is a distance in the real space per unit pixel of the image.

Specifically, the resolution calculation unit 32 calculates the pixel resolution that is a distance in the real space per unit pixel in the image. Then, the relative position calculation unit 33 calculates the second relative position by using the in-image target position P_{1M} and the in-image irradiation position P_{4M} that are positions in the image corresponding to the position P₁ of the target and the irradiation position P₄ in the real space, the pixel resolution that is a distance in the real space per unit pixel of the image, and the design relative position.

In step S17, the information processing device 30 calculates the first absolute position P₁ on the basis of the second absolute position P₂, the first relative position that is a relative position of the laser range finder 22 from the position measurement instrument 21, the measurement distance L₁, the distance measurement direction, and the second relative position that is a relative position of the target with respect to the measurement position P₃.

In the above measurement method, step S15 and step S16 may not be executed. For example, the second relative position may be calculated by using any other method, and the information processing device 30 may calculate the first absolute position P₁ on the basis of the second relative position calculated by using the method.

As described above, according to the present embodiment, the measurement system 100 measures the first absolute position P₁ that is the absolute position P₁ of the target in the internal space B provided underground A. The measurement system 100 includes the measurement device 20 and the information processing device 30. The measurement device 20 includes: the position measurement instrument 21, which is the position measurement instrument 21 that measures the second absolute position P₂ that is an absolute position of the position measurement instrument 21 by using a signal received from a satellite; the laser range finder 22 that measures the measurement distance L₁ that is a distance from the measurement position P₃; and the orientation measurement instrument 24 that measures the orientation in the distance measurement direction of the laser range finder 22. The information processing device 30 includes the absolute position calculation unit 34 that calculates the first absolute position P₁ on the basis of the first relative position that is a relative position of the laser range finder 22 with respect to the second absolute position P₂, the second relative position that is a relative position of the target with respect to the measurement position P₃, the second absolute position, the measurement distance L₁, and the orientation when the measurement device 20 is installed such that the position measurement instrument 21 is located on the ground and the laser range finder 22 is located in the internal space B such that the distance measurement direction is the horizontal direction.

Therefore, the worker can easily measure the first absolute position P₁ that is the absolute position P₁ of the target in the internal space B provided underground A with high accuracy by using the measurement system 100. Specifically, the absolute position P₁ of the target in the internal space B where a GNSS signal does not reach can be measured. Further, human errors that occur when the worker uses a measure or the like in the small internal space B with low workability can be reduced, and the absolute position P₁ of the target can be measured with high accuracy. The worker can also measure the absolute position P₁ of the target without entering the internal space B. In this case, safety of the worker can be further improved.

According to the present embodiment, in the measurement system 100, the target is the opening on the side surface of the structure 10 defining the internal space B, the measurement position P₃ is a position on the side surface, the measurement device 20 further includes the laser pointer 26 that is disposed at the design relative position with respect to the laser range finder 22 and emits a laser beam in a direction parallel to the distance measurement direction and the imaging unit 28 that generates an image by imaging the area including the position P₁ of the target and the irradiation position P₄ of the laser beam, and the information processing device 30 further includes the relative position calculation unit 33 that calculates the second relative position by using the in-image target position P_{1M} and the in-image irradiation position P_{4M} that are positions in the image corresponding to the position P₁ of the target and the irradiation position P₄ in the real space, the pixel resolution that is a distance in the real space per unit pixel of the image, and the design relative position. Therefore, the worker does not need to measure the second relative position that is a relative position of the target with respect to the measurement position P₃ by using a measure or the like. This makes it possible to suppress a measurement error caused by measurement using the measure. Therefore, the worker can measure the first absolute position P₁ with higher accuracy by using the measurement system 100.

### First Modification

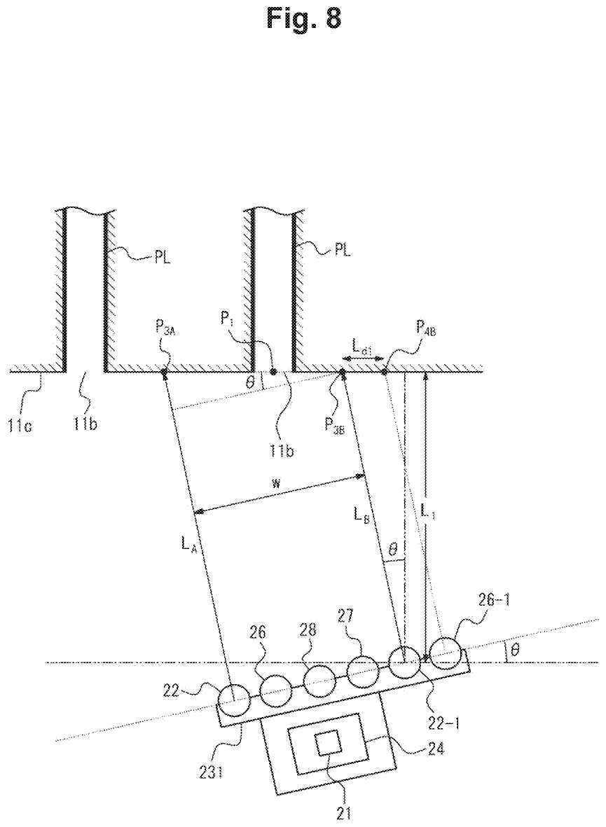

In the above embodiment, in addition to the position measurement instrument 21, the laser range finder 22, the jig 23, the orientation measurement instrument 24, the level 25, the laser pointer 26, the lighting device 27, and the imaging unit 28 in FIG. 3A, the measurement device 20 may further include an additional laser range finder 22-1 different from the laser range finder 22 and an additional laser pointer 26-1 different from the laser pointer 26 as shown in FIG. 8. In the present modification, the laser range finder 22 and the laser pointer 26 described above are also referred to as a first laser range finder 22 and a first laser pointer 26, respectively. The additional laser range finder 22-1 and the additional laser pointer 26-1 are also referred to as a second laser range finder 22-1 and a second laser pointer 26-1, respectively.

In the first modification, the first laser range finder 22 measures a measurement distance L_{A} from the first laser range finder 22 to a first measurement position P_{3A}. The first measurement position P_{3A} is a position on the duct surface 11c located in the distance measurement direction from the first laser range finder 22.

The second laser range finder 22-1 is provided at a predetermined relative position with respect to the first laser range finder 22. In the example of FIG. 8, the second laser range finder 22-1 is installed apart by a predetermined distance w in a direction orthogonal to the distance measurement direction of the first laser range finder 22. The second laser range finder 22-1 measures a measurement distance L_{B} from the second laser range finder 22-1 to a second measurement position P_{3B}. The second measurement position P_{3B} is a position on the duct surface 11c located in the distance measurement direction from the second laser range finder 22-1. The second laser range finder 22-1 may be provided on the installation base 231.

The second laser pointer 26-1, as well as the first laser pointer 26, is installed at the design relative position with respect to the second laser range finder 22-1 and emits a laser beam in a direction parallel to the distance measurement direction. The second laser pointer 26-1 may be provided on the installation base 231.

The relative position calculation unit 33 can calculate the second relative position on the basis of the measurement distance L_{A} measured by the first laser range finder 22 (laser range finder) and the measurement distance L_{B} measured by the second laser range finder 22-1 (additional laser range finder).

Specifically, the relative position calculation unit 33 calculates an angle θ between the distance measurement direction and the normal direction of the duct surface 11c from Equation (4) by using the measurement distance L_{A}, the measurement distance L_{B}, and a distance between the laser beam emitted by the first laser range finder 22 and the laser beam emitted by the second laser range finder 22-1. The distance between the laser beam emitted by the first laser range finder 22 and the laser beam emitted by the second laser range finder 22-1 is a predetermined distance w from the second laser range finder 22-1 in a direction orthogonal to the distance measurement direction of the first laser range finder 22.

$$\begin{matrix}[ Math . 1 ] & \\ θ = arctan \frac{{L}_{A} - {L}_{B}}{w} & ( 4 )\end{matrix}$$

The relative position calculation unit 33 calculates a distance L_{d1} from an irradiation position P_{4B} of the second laser pointer 26-1 to a second measurement position P_{3B} of the second laser range finder 22-1 from Equation (5). Then, the relative position calculation unit 33 can set a position at the distance L_{d1} in an in-plane direction from the irradiation position P₄ as the above design relative position.

$$\begin{matrix}[ Math . 2 ] & \\ {L}_{d 1} = \frac{{L}_{d}}{cos θ} & ( 5 )\end{matrix}$$

The absolute position calculation unit 34 measures the distance L₁ in the normal direction of the side surface (duct surface 11c) on the basis of the measurement distance L_{A} measured by the first laser range finder 22 and the measurement distance L_{B} measured by the second laser range finder 22-1.

Specifically, the absolute position calculation unit 34 calculates the distance L₁ from the second laser range finder 22-1 to the duct surface 11c in the normal direction of the duct surface 11c from Equation (6).

$${L}_{1} = {L}_{B} cos θ \qquad ( 6 )$$

Then, the absolute position calculation unit 34 can calculate the first absolute position P₁ on the basis of the distance L₁ in the normal direction calculated from Equation (6) as in the above embodiment. Specifically, the absolute position calculation unit 34 can calculate, as the absolute position P₁ of the target, a position that is apart from the position (position of the second laser range finder 22-1) located at a predetermined relative position with respect to the second absolute position P₂ by the distance L₁ in the normal direction calculated from Equation (6) in the normal direction of the duct surface 11c and is apart from the irradiation position P_{4B} by the sum of the distance L_{d1} calculated from Equation (5) and a distance between the irradiation position P_{4B} and the position P₁ of the target, which is calculated on the basis of the pixel resolution, in the horizontal direction in the plane of the duct surface 11c.

According to the first modification, even in a case where the distance measurement directions of the first laser range finder 22 and the second laser range finder 22-1 installed by visual confirmation by the worker deviate from the normal direction of the duct surface 11c, the distance from the second laser range finder 22-1 to the duct surface 11c can be measured with high accuracy. Therefore, the measurement system 100 can measure the absolute position P₁ of the target with high accuracy.

In the first modification, the measurement device 20 may include three or more laser range finders 22. In such a configuration, the information processing device 30 may perform the above processing by excluding a distance having a difference larger than a predetermined threshold from distances measured by other laser range finders 22 among distances measured by the three or more laser range finders 22. Thus, the distance that has not been accurately measured due to an influence of the duct outlet 11b, the communication cable, and the like in the internal space B is excluded. Therefore, the measurement system 100 can measure the absolute position P₁ of the target with high accuracy.

In the first modification, the information processing device 30 may calculate an average value of distances calculated by a plurality of laser range finders 22 as a distance from the laser range finders 22 to the duct surface 11c in the normal direction.

### Second Modification

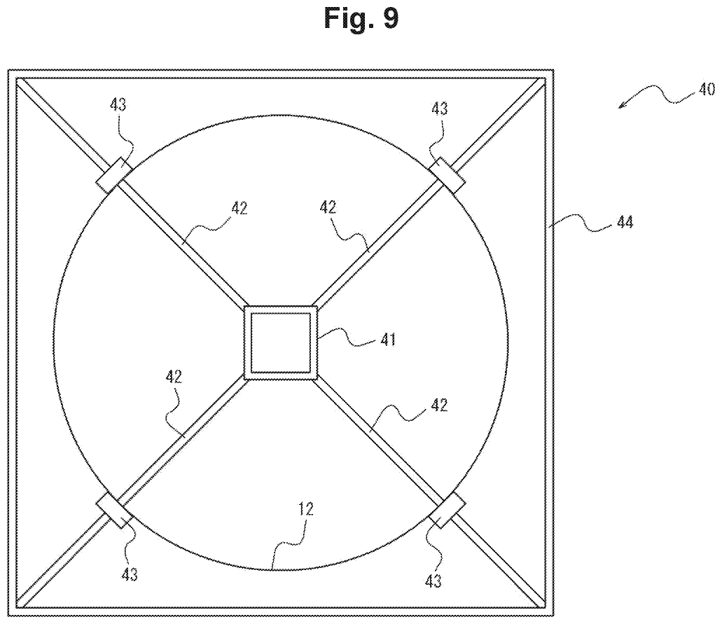

In the above embodiment, the measurement system 100 may further include a fixing tool 40. The fixing tool 40 includes an inner frame 41, a plurality of frame holding members 42, the same number of guide members 43 as the frame holding members 42, and an outer frame 44. In the example of FIG. 9, the numbers of frame holding members 42 and guide members 43 included in the fixing tool 40 are four, but the present invention is not limited thereto. Each member included in the fixing tool 40 may be made from a material that does not deform and may be made from, for example, aluminum.

The inner frame 41 regulates displacement of the jig 23 in a direction orthogonal to the extending direction of the jig 23. In the example of FIG. 9, the inner frame 41 forms a rectangular peripheral edge and can surround the jig 23 in a direction orthogonal to the extending direction.

Each frame holding member 42 is fixed to a part of the inner frame 41 and extends from the part to the outside of the inner frame 41. The frame holding member 42 has a scale indicating a distance from the inner frame 41. In a case where the center of the rectangle formed by the inner frame 41 is installed to be located at the center of the opening of the structure 10 which communicates the internal space B with the ground C, the frame holding member 42 has a length extending to the outside of the opening.

The guide member 43 is a member movable along the frame holding member 42. When the rectangle formed by the inner frame 41 is installed to be located in the opening of the structure 10, each of the plurality of guide members 43 is moved by the worker, for example, such that distances from the inner frame 41 to the guide members 43 are the same and is held at the peripheral edge of the opening. Thus, the fixing tool 40 is installed such that the center of the rectangle formed by the inner frame 41 is located at the center of the opening. Therefore, the jig 23 fixed by the inner frame 41 is installed to be located at the center of the opening of the structure 10, the opening communicating the internal space B with the ground C.

The outer frame 44 is a frame to which outer ends of the frame holding members 42 included in the fixing tool 40 are connected. In the example of FIG. 9, the outer frame 44 forms a rectangular peripheral edge having a side longer than the diameter of the opening of the structure 10.

In the second modification, the jig 23 is fixed by the inner frame 41 and is installed to be located at the center of the opening of the structure 10 such as a manhole. Therefore, for example, it is possible to reduce a possibility of collision with the ladder 14 provided on the end side of the internal space B when the measurement device 20 including the jig 23 is lowered from the ground C to the internal space B. This makes it possible to reduce a possibility of damage due to collision with the ladder 14 when the measurement device 20 is installed.

In the second modification, because the jig 23 is installed at the center of the opening, the position measurement instrument 21 is installed at the center of the opening when the extending direction of the jig 23 is installed in the vertical direction. Therefore, in a case where the first absolute position P₁ in the internal space B of each of a plurality of structures 10 is measured, the second absolute positions P₂ used to measure the respective first absolute positions P₁ can be aligned with the center of the opening.

In the second modification, because the guide member 43 is movable along the frame holding member 42, the fixing tool 40 can be applied to the structure 10 having openings of various sizes.

### <Program>

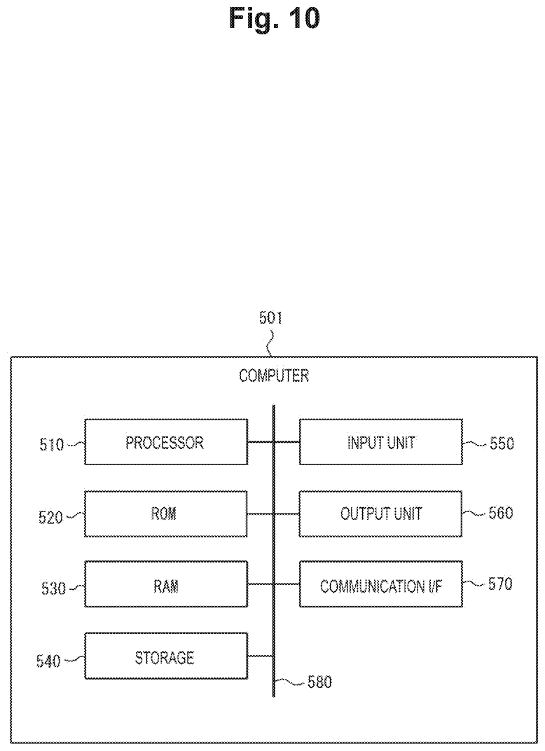

The information processing device 30 described above can be implemented by a computer 501. Further, a program for causing the computer to function as the information processing device 30 described above may be provided. The program may be stored in a storage medium or may be provided via a network. FIG. 10 is a block diagram showing a schematic configuration of the computer 501 functioning as the information processing device 30. Here, the computer 501 may be a general-purpose computer, a dedicated computer, a workstation, a personal computer (PC), an electronic notepad, or the like. Program instructions may be program codes, code segments, or the like for performing required tasks.

As shown in FIG. 10, the computer 501 includes a processor 510, a read only memory (ROM) 520, a random access memory (RAM) 530, a storage 540, an input unit 550, an output unit 560, and a communication interface (I/F) 570. The components are communicably connected to each other via a bus 580. Specifically, the processor 510 is a central processing unit (CPU), a micro processing unit (MPU), a graphics processing unit (GPU), a digital signal processor (DSP), a system on a chip (SoC), or the like and may include a plurality of processors of the same or different types.

The processor 510 executes control on the components and various types of arithmetic processing. That is, the processor 510 reads the program from the ROM 520 or the storage 540 and executes the program by using the RAM 530 as a work area. The processor 510 performs control on the components and various types of arithmetic processing in accordance with the program stored in the ROM 520 or the storage 540. In the embodiments described above, the program according to the present disclosure is stored in the ROM 520 or the storage 540.

The program may be stored in a storage medium readable by the computer 501. By using such a storage medium, it is possible to install the program in the computer 501. Here, the storage medium in which the program is stored may be a non-transitory storage medium. The non-transitory storage medium is not particularly limited, but may be, for example, a CD-ROM, a DVD-ROM, or a universal serial bus (USB) memory. The program may be downloaded from an external device via a network.

The ROM 520 stores various programs and various frames. The RAM 530 temporarily stores a program or frame as a working area. The storage 540 includes a hard disk drive (HDD) or a solid state drive (SSD) and stores various programs including an operating system and various frames.

The input unit 550 includes one or more input interfaces that receive a user's input operation and acquire information based on the user's operation. For example, the input unit 550 is a pointing device, a keyboard, a mouse, or the like, but is not limited thereto.

The output unit 560 includes one or more output interfaces that output information. The output unit 560 is a display that outputs information as video images or a speaker that outputs information as sound, for example, but is not limited thereto. The output unit 560 also functions as the input unit 550 in a case where the output unit is a touch panel display.

The communication interface (I/F) 570 is an interface for communicating with an external device.

Regarding the above embodiment, the following supplementary notes are further disclosed.

### [Supplementary Note 1]

A measurement system that measures a first absolute position that is an absolute position of a target in an internal space provided underground, the measurement system comprising: a measurement device; and an information processing device, in which:
the measurement device includes
a position measurement instrument that measures a second absolute position that is an absolute position of the position measurement instrument by using a signal received from a satellite,
a laser range finder that measures a measurement distance that is a distance from a measurement position, and
an orientation measurement instrument that measures an orientation in a distance measurement direction of the laser range finder;
the information processing device includes a controller; and
the controller calculates the first absolute position on the basis of a first relative position that is a relative position of the laser range finder with respect to the second absolute position and a second relative position that is a relative position of the target with respect to the measurement position, the second absolute position, the measurement distance, and the orientation when the measurement device is installed such that the position measurement instrument is located on the ground and the laser range finder is located in the internal space such that the distance measurement direction is a horizontal direction.

### [Supplementary Note 2]

The measurement system according to supplementary note 1, in which:
the target is an opening on a side surface of a structure defining the internal space, and the measurement position is a position on the side surface;
the measurement device further includes
a laser pointer that is disposed at a design relative position with respect to the laser range finder and emits a laser beam in a direction parallel to the distance measurement direction, and
a camera that generates an image by imaging an area including the position of the target and an irradiation position of the laser beam; and
the controller calculates the second relative position by using an in-image target position and an in-image irradiation position that are positions in the image corresponding to the position of the target and the irradiation position in a real space, a pixel resolution that is a distance in the real space per unit pixel of the image, and the design relative position.

### [Supplementary Note 3]

The measurement system according to supplementary note 1 or 2, in which;
the measurement device further includes
a jig that holds the position measurement instrument and an installation base on which the laser range finder is provided along an extending direction and holds the laser range finder such that the distance measurement direction is orthogonal to the extending direction, and
a level indicating whether or not the extending direction is a vertical direction; and
the second absolute position is the absolute position of the position measurement instrument when the distance measurement direction becomes the horizontal direction by installing the jig by using the level such that the extending direction is the vertical direction.

### [Supplementary Note 4]

The measurement system according to supplementary note 3, in which:
the jig is provided with a scale indicating a distance in the extending direction of the jig; and
the first relative position is calculated by using the distance indicated by the scale when the level indicates that the extending direction is the vertical direction.

### [Supplementary Note 5]

The measurement system according to supplementary note 2, in which:
the measurement device further includes an additional laser range finder different from the laser range finder, the additional laser range finder measuring a measurement distance that is a distance from a measurement position; and
the controller calculates the second relative position on the basis of the distance measured by the laser range finder and the distance measured by the additional laser range finder,
measures a distance in a normal direction of the side surface on the basis of the measurement distance measured by the laser range finder and the measurement distance measured by the additional laser range finder, and calculates the first absolute position on the basis of the distance in the normal direction.

### [Supplementary Note 6]

The measurement system according to supplementary note 3 or 4, further including
a fixing tool, in which
the fixing tool includes
an inner frame that regulates displacement of the jig in a direction orthogonal to the extending direction of the jig,
a frame holding member that is fixed to each part of the inner frame and extends from the each part to outside of the inner frame, and
a guide member movable along the frame holding member.

### [Supplementary Note 7]

A measurement method for measuring a first absolute position that is an absolute position of a target in an internal space provided underground, the measurement method including:
installing a measurement device including a position measurement instrument that measures a second absolute position that is an absolute position of the position measurement instrument by using a signal received from a satellite and a laser range finder that measures a measurement distance that is a distance from a measurement position, the installing being installing the measurement device such that the position measurement instrument is located on the ground and the laser range finder is located in the internal space such that a distance measurement direction of the laser range finder is a horizontal direction;
measuring the second absolute position;
measuring an orientation in the distance measurement direction;
measuring the measurement distance;
and
calculating the first absolute position on the basis of a first relative position that is a relative position of the laser range finder with respect to the second absolute position and a second relative position that is a relative position of the target with respect to the measurement position, the second absolute position, the measurement distance, and the orientation in the distance measurement direction when the measurement device is installed such that the position measurement instrument is located on the ground and the laser range finder is located in the internal space.

### [Supplementary Note 8]

The measurement method according to supplementary note 7, in which:
the target is an opening on a side surface of a structure defining the internal space, and the measurement position is a position on the side surface;
a laser pointer that emits a laser beam in a direction parallel to the distance measurement direction is disposed at a design relative position with respect to the laser range finder;
an image is generated by imaging an area including the position of the target and an irradiation position of the laser beam; and
the second relative position is calculated by using an in-image target position and an in-image irradiation position that are positions in the image corresponding to the position of the target and the irradiation position in a real space, a pixel resolution that is a distance in the real space per unit pixel of the image, and the design relative position.

All the literatures, patent applications, and techniques mentioned in this specification are incorporated herein by reference to the same extent as if each individual literature, patent application, and technique were specifically and individually described to be incorporated by reference.

Although the above-described embodiment has been described as a representative example, it is apparent to those skilled in the art that many changes and substitutions can be made within the spirit and scope of the present disclosure. Thus, it should not be understood that the present invention is limited by the above-described embodiments, and various modifications or changes can be made without departing from the scope of the claims.

### REFERENCE SIGNS LIST

10 Structure
11 Framework portion
11a Duct portion
11b Duct outlet
11c Duct surface
12 Neck portion
13 Iron lid
14 Ladder
15 Cable attaching member
20 Measurement device
21 Position measurement instrument
22 Laser range finder (first laser range finder)
22-1 Additional laser range finder (second laser range finder)
23 Jig
23a First jig portion
23b Second jig portion
23c Third jig portion
24 Orientation measurement instrument
25 Level
26 Laser pointer (first laser pointer)
26-1 Additional laser pointer (second laser pointer)
27 Lighting device
28 Imaging unit
30 Information processing device
31 Input unit
32 Resolution calculation unit
33 Relative position calculation unit
34 Absolute position calculation unit
35 Output unit
40 Fixing tool
41. Inner frame
42 Frame holding member
43 Guide member
44 Outer frame
100 Measurement system
231 Installation base
232 Base
501 Computer
510 Processor
520 ROM
530 RAM
540 Storage
550 Input unit
560 Output unit
570 Communication interface
580 Bus

1. A measurement system for measuring a first absolute position that is an absolute position of a target in an internal space provided underground, the measurement system comprising:
a measurement device; and
an information processing device, wherein:
the measurement device comprises:
a position measurement instrument that measures a second absolute position,
the second absolute position representing an absolute position of the position measurement instrument by using a signal received from a satellite,
a laser range finder that performs measuring a measurement distance,
the measurement distance representing a distance from a measurement position, and
an orientation measurement instrument that performs measuring an orientation in a distance measurement direction of the laser range finder; and
the information processing device comprises an information processor executing computer-executable instructions that when executed performs operations comprising:
when the measurement device is installed such that the position measurement instrument is located on the ground and the laser range finder is located in the internal space such that the distance measurement direction is a horizontal direction, calculating the first absolute position on the basis of a first relative position, a second relative position, the second absolute position, the measurement distance, and the orientation, wherein the first relative position represents a relative position of the laser range finder with respect to the second absolute position, and the second relative position represents a relative position of the target with respect to the measurement position.

2. The measurement system according to claim 1, wherein:
the target represents an opening on a side surface of a structure defining the internal space, and the measurement position is a position on the side surface;
the measurement device further includes:
a laser pointer that is disposed at a design relative position with respect to the laser range finder and emits a laser beam in a direction parallel to the distance measurement direction, and
a measurement processor that executes operations comprising: generating an image by imaging an area including the position of the target and an irradiation position of the laser beam; and
the information processor further executes operations comprising: calculating the second relative position by using an in-image target position and an in-image irradiation position that are positions in the image corresponding to the position of the target and the irradiation position in a real space, a pixel resolution that is a distance in the real space per unit pixel of the image, and the design relative position.

3. The measurement system according to claim 1, wherein:
the measurement device further includes:
a jig that holds the position measurement instrument and an installation base on which the laser range finder is provided along an extending direction and holds the laser range finder such that the distance measurement direction is orthogonal to the extending direction, and
a level indicating whether or not the extending direction is a vertical direction; and
the second absolute position is the absolute position of the position measurement instrument when the distance measurement direction becomes the horizontal direction by installing the jig by using the level such that the extending direction is the vertical direction.

4. The measurement system according to claim 3, wherein:
the jig is provided with a scale indicating a distance in the extending direction of the jig; and
the first relative position is calculated by using the distance indicated by the scale when the level indicates that the extending direction is the vertical direction.

5. The measurement system according to claim 2, wherein:
the measurement device further includes an additional laser range finder different from the laser range finder, the additional laser range finder measuring a measurement distance that is a distance from a measurement position;
the relative position calculation unit calculates the second relative position on the basis of the distance measured by the laser range finder and the distance measured by the additional laser range finder; and
the absolute position calculation unit measures a distance in a normal direction of the side surface on the basis of the measurement distance measured by the laser range finder and the measurement distance measured by the additional laser range finder and calculates the first absolute position on the basis of the distance in the normal direction.

6. The measurement system according to claim 3, further comprising
a fixing tool, wherein
the fixing tool includes:
an inner frame that adjusts displacement of the jig in a direction orthogonal to the extending direction of the jig,
a frame holding member that is fixed to each part of the inner frame and extends from said each part to outside of the inner frame, and
a guide member movable along the frame holding member.

7. A measurement method for measuring a first absolute position that is an absolute position of a target in an internal space provided underground, the measurement method comprising:
installing a measurement device, wherein the measurement device comprises
a position measurement instrument that performs measuring a second absolute position
the second absolute position representing an absolute position of the position measurement instrument by using a signal received from a satellite and a laser range finder,
the laser range finder that performs measuring a measurement distance,
the measurement distance representing a distance from a measurement position,
the installing further comprises installing the measurement device such that the position measurement instrument is located on the ground and the laser range finder is located in the internal space such that a distance measurement direction of the laser range finder is a horizontal direction;
measuring the second absolute position;
measuring an orientation in the distance measurement direction;
measuring the measurement distance; and
when the measurement device is installed such that the position measurement instrument is located on the ground and the laser range finder is located in the internal space, calculating the first absolute position on the basis of a first relative position that is a relative position of the laser range finder with respect to the second absolute position and a second relative position that is a relative position of the target with respect to the measurement position, the second absolute position, the measurement distance, and the orientation in the distance measurement direction.

8. The measurement method according to claim 7, wherein:
the target represents an opening on a side surface of a structure defining the internal space, and the measurement position is a position on the side surface;
a laser pointer that emits a laser beam in a direction parallel to the distance measurement direction is disposed at a design relative position with respect to the laser range finder; and
the measurement method further comprises
generating an image by imagining an area including the position of the target and an irradiation position of the laser beam, and
calculating the second relative position by using an in-image target position and an in-image irradiation position that are positions in the image corresponding to the position of the target and the irradiation position in a real space, a pixel resolution that is a distance in the real space per unit pixel of the image, and the design relative position.
